(19) United States
(12) Patent Application Publication
(10) Pub. No.: US 2026/0277233 A1
(43) Pub. Date: Sep. 17, 2026

(54) ROBOT CONTROL USING RETURN DATA

(71) Applicant: GDM Holding LLC, Mountain View, CA (US)

(72) Inventors: Charles Blundell, London (GB); Benigno Uria-Martínez, London (GB)

(21) Appl. No.: 19/078,880

(22) Filed: Mar. 13, 2025

(51) Int. Cl. G05D 1/646; G05D 1/648; G05D 101/15

(52) U.S. Cl. CPC G05D 1/646; G05D 1/648; G05D 2101/15

(57) ABSTRACT

Methods, systems, and apparatus for robot control using return data. One method includes maintaining return data that records outcomes of past robot actions, in which the return data maps each observation-action pair to a respective return, the action in each observation-action pair being an action that was performed by the robot in response to the observation in the observation-action pair and the respective return mapped to by each of the observation-action pairs being a return that resulted from the robot performing the action in the observation-action pair; receiving a current observation from one or more sensors of the robot; determining whether the current observation matches any observation identified in the return data; and in response to determining that the current observation matches a first observation identified in the return data, selecting an action to be performed by the robot.

### BACKGROUND

This specification relates to robot control using return data.

In a robot control system, a robot interacts with an environment by performing actions that are selected by the system in response to receiving observations that characterize the current state of the environment.

### SUMMARY

This specification describes how a system implemented as computer programs on one or more computers in one or more locations can select an action to be performed by a robot interacting with an environment from a predetermined set of actions using return data maintained by the system.

In general, one innovative aspect may be embodied in a method for selecting an action from a predetermined set of actions to be performed by a robot interacting with an environment, the method comprising: maintaining return data that maps each of a plurality observation-action pairs to a respective return, wherein the action in each observation-action pair is an action that was performed by the robot in response to the observation in the observation-action pair, and wherein the respective return mapped to by each of the observation-action pairs is a return that resulted from the robot performing the action in the observation-action pair in response to the observation in the observation-action pair; receiving a current observation characterizing a current state of the environment; determining whether the current observation matches any of the observations identified in the return data; and in response to determining that the current observation matches a first observation identified in the return data, selecting an action to be performed by the robot in response to the current observation using the returns mapped to by observation-action pairs in the return data that include the first observation.

Selecting the action to be performed by the robot may comprise: selecting an action that, according to the return data, resulted in a highest return of any action when performed by the robot in response to the first observation. Selecting the action to be performed by the robot may comprise: selecting an action that, according to the return data, resulted in a highest return of any action when performed by the robot in response to the first observation with probability 1-ε; and selecting an action randomly from the predetermined set of actions with probability ε.

The method may further comprise: in response to determining that the current observation does not match any of the observations identified in the return data: determining a feature representation of the current observation; determining the k observations identified in the return data that have feature representations that are closest to the feature representation of the current observation, wherein k is an integer greater than one; determining a respective estimated return for each of a plurality of actions in the predetermined set of actions from returns mapped to by observation-action pairs in the return data that include the action and any one of the k observations; and selecting the action to be performed by the robot in response to the current observation using the estimated returns. Determining a respective estimated return may comprise, for each of the plurality of actions: determining an average of the returns mapped to by observation-action pairs in the return data that include the action and any one of the k observations. Selecting the action to be performed by the robot may comprise: selecting an action from the plurality of actions that has the highest estimated return. Selecting the action to be performed by the robot may comprise: selecting an action from the plurality of actions that has the highest estimated return with probability 1-ε; and selecting an action randomly from the predetermined set of actions with probability ε. Determining the k observations identified in the return data that have feature representations that are closest to the feature representation of the current observation may comprise: determining the k observations identified in the return data that have feature representations that have a smallest Euclidian distance to the feature representation of the current observation. The feature representation of the current observation may be the current observation. Determining the feature representation of the current observation may comprise: projecting the current observation into a smaller-dimensional space. Projecting the current observation into the smaller-dimensional space may comprise applying a random projection matrix to the current observation. Determining the feature representation of the current observation may comprise: processing the current observation using a variational auto-encoder model to generate a latent representation of the current observation; and using the latent representation of the current observation as the feature representation of the current observation.

The method may further comprise: receiving a new return resulting from the robot performing the selected action in response to the current observation; and updating the return data using the new return. When the current observation matches a first observation identified in the return data, updating the return data using the new return may comprise: determining whether the new return is larger than an existing return resulting from performing the selected action in response to the first observation according to the return data; and when the new return is larger than the existing return, replacing the existing return with the new return in the return data. When the current observation does not match a first observation identified in the return data, updating the return data using the new return may comprise: updating the return data to map a current observation-selected action pair to the new return.

The method may further comprise: determining that a number of mappings in the return data has reached a maximum size and, in response, removing a least recently updated mapping from the return data. The method may further comprise: initializing the return data with initial mappings by randomly selecting actions to be performed by the robot until each action in the predetermined set of actions has been performed more than a threshold number of times. The returns may be discounted sums of rewards received by the robot in response to performing actions.

It will be appreciated that aspects can be implemented in any convenient form. For example, aspects and implementations may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs.

The subject matter described in this specification can be implemented in particular embodiments so as to realize one or more of the following advantages. The reinforcement learning system can effectively select actions to be performed by a robot in order to complete a task without the need to model the behavior of the robot, e.g., by using a model-free controller. A model-free controller can be used to control a robot in an environment with near-deterministic states and rewards. The environment may be a real-world environment in which an object in the real-world environment is controlled. The subject matter described in this specification can enable a model-free controller to exploit the near-deterministic characteristics of the environment to quickly select an action for the robot to perform in response to a current observation. In particular, by maintaining return data that maps each of multiple observation-action pairs to a respective return that is the highest return that resulted from the robot performing the action in the observation-action pair in response to the observation in the observation-action pair, the model-free controller can quickly select a highly rewarding action for the robot to perform in response to the current observation by using the return data. In addition, the model-free controller can reduce memory and computational requirements by projecting observations into a smaller-dimensional space. Thus, by using the model-free controller, the reinforcement learning system can reduce computation time and resources needed for selecting an action to be performed by the robot in response to a current observation. Aspects may therefore address problems associated with efficient and effective selection of actions for control of a robot.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example reinforcement learning system.

FIG. 2 is a flow diagram of an example process for selecting an action to be performed by an agent.

FIG. 3 is a flow diagram of an example process for selecting an action to be performed by an agent in response to a new observation.

Like reference numbers and designations in the various drawings indicate like elements.

### DETAILED DESCRIPTION

This specification generally describes a reinforcement learning system that selects actions to be performed by a reinforcement learning agent interacting with an environment. In order to interact with the environment, the agent receives data characterizing the current state of the environment and performs an action from an action space in response to the received data. Data characterizing a state of the environment will be referred to in this specification as an observation.

In some implementations, the environment is a simulated environment and the agent is implemented as one or more computers interacting with the simulated environment. For example, the simulated environment may be a video game and the agent may be a simulated user playing the video game.

In some other implementations, the environment is a real-world environment and the agent is a mechanical agent interacting with the real-world environment. For example, the agent may be a robot interacting with the environment to accomplish a specific task. As another example, the agent may be an autonomous or semi-autonomous vehicle navigating through the environment. In these cases, the observation can be data captured by one or more sensors of the mechanical agent as it interacts with the environment, e.g., a camera, a lidar sensor, a temperature sensor, and so on.

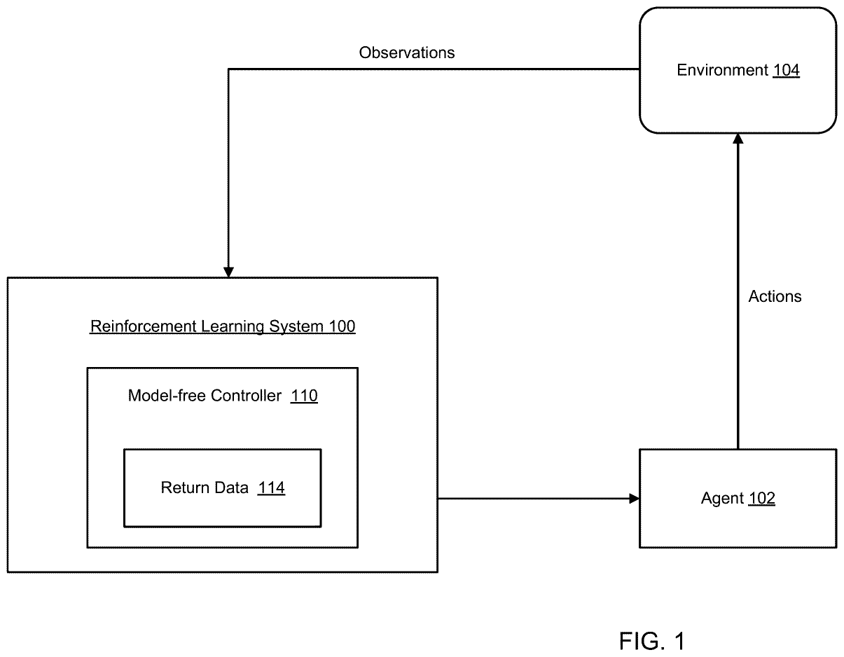

FIG. 1 shows an example reinforcement learning system 100. The reinforcement learning system 100 is an example of a system implemented as computer programs on one or more computers in one or more locations in which the systems, components, and techniques described below are implemented.

The reinforcement learning system 100 selects actions to be performed by a reinforcement learning agent 102 interacting with an environment 104. That is, the reinforcement learning system 100 receives observations, with each observation characterizing a respective state of the environment 104, and, in response to each observation, selects an action from an action space to be performed by the reinforcement learning agent 102 in response to the observation. After the agent 102 performs a selected action, the environment 104 transitions to a new state and the system 100 receives another observation characterizing the next state of the environment 104 and a reward. The reward can be a numeric value that is received by the system 100 or the agent 102 from the environment 104 as a result of the agent 102 performing the selected action.

To select an action to be performed by the agent 102 in response to an observation, the reinforcement learning system 100 includes a model-free controller 110. Generally, the model-free controller 110 can rapidly record and replay a sequence of actions that were performed by the agent 102 and so far yielded the highest return. In some cases, the model-free controller 110 is a non-parametric model. In some other cases, the model-free controller 110 includes a neural network. In particular, the controller 110 maintains return data 114 that maps each of multiple observation-action pairs to a respective return. An observation-action pair includes an observation characterizing a state of the environment 104 and an action that is performed by the agent 102 in response to the observation. The respective return mapped to by each of the observation-action pairs is a time-discounted combination, e.g., a sum or an average, of rewards received by the system 100 or the agent 102 after the agent 102 performed the action in the observation-action pair in response to the observation in the observation-action pair.

In some implementations, the controller 110 initializes the return data 114 with initial mappings by randomly selecting actions to be performed by the agent 102 in response to observations, e.g., until each action in a predetermined set of actions has been performed more than a threshold number of times or until a threshold number of total actions have been performed. The controller 110 then collects returns that resulted from the agent 102 performing the randomly selected actions and maps each observation-action pair with a respective return.

In some implementations, the return data 114 can be stored as a growing table, indexed by observation-action pairs. A value stored at a particular observation-action pair index in the growing table includes a highest return that the system 100 ever obtained as a result of the agent 102 performing the action in the particular observation-action pair in response to the observation in the particular observation-action pair.

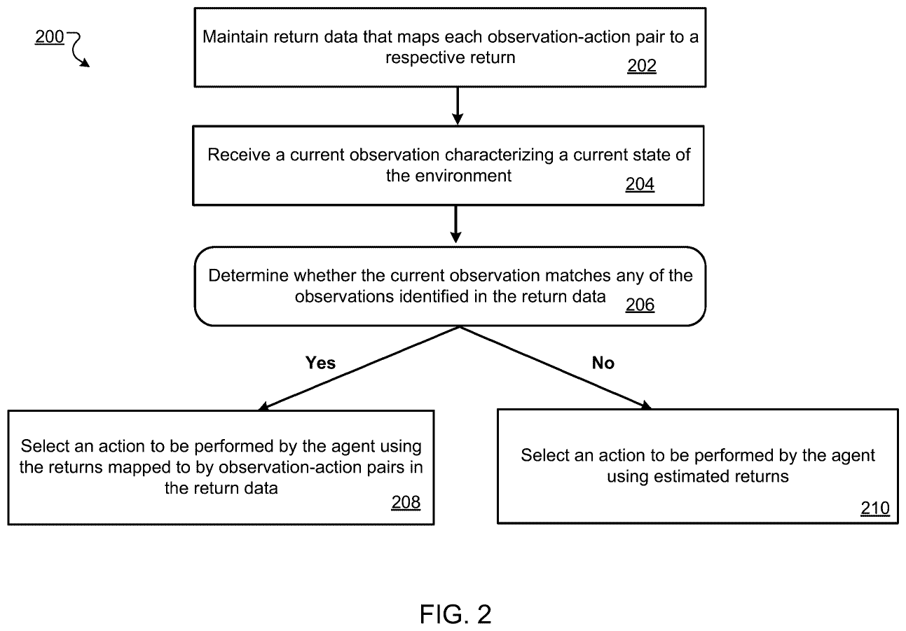

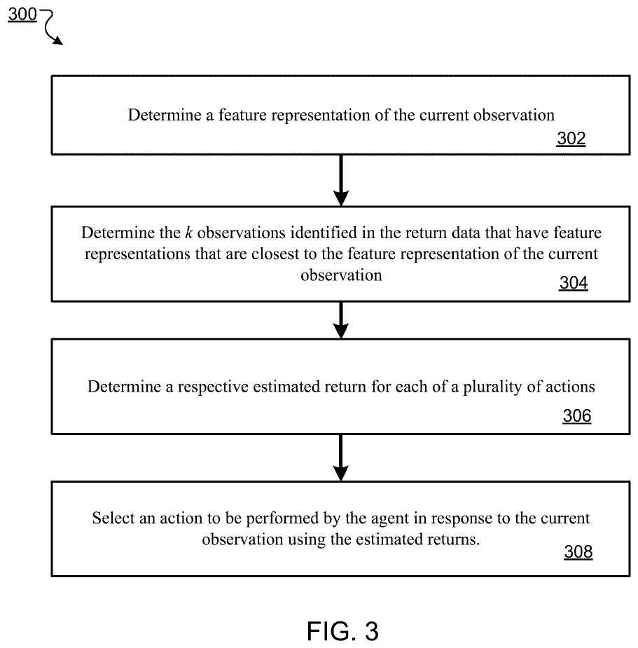

Each time the system 100 receives a current observation charactering a current state of the environment 104, the controller 110 selects an action to be performed by the agent 102 in response to the current observation based on the return data 114. Selecting an action based on the return data 114 is described in more detail below with reference to FIG. 2 and FIG. 3.

FIG. 2 is a flow diagram of an example process 200 for selecting an action to be performed by an agent based on return data. For convenience, the process 200 will be described as being performed by a system of one or more computers located in one or more locations. For example, a reinforcement learning system, e.g., the reinforcement learning system 100 of FIG. 1, appropriately programmed in accordance with this specification, can perform the process 200.

The system maintains return data that maps each of a plurality of observation-action pairs to a respective return (step 202). As described above, the return data maps each of multiple observation-action pairs to a respective return.

The system receives a current observation characterizing a current state of the environment (step 204).

After receiving the current observation characterizing the current state of the environment, the system determines whether the current observation matches any of the observations in the observation-action pairs in the return data (step 206). In some implementations, the current observation matches another observation if it is the same as the other observation. In some other implementations, the current observation matches another observation if it is within a threshold distance of the other observation according to an appropriate distance metric (e.g., Euclidian distance).

In response to determining that the current observation matches a first observation that is identified in the return data, the system selects an action to be performed by the agent in response to the current observation using the returns mapped to by observation-action pairs in the return data that include the first observation (step 208).

In some implementations, the system selects an action that, according to the return data, resulted in a highest return of any action when performed by the agent in response to the first observation. That is, the system identifies, from the observation-action pairs in the return data that include the first observation, the pair that is mapped to the highest return and selects the action from the identified pair.

In some other implementations, the system selects an action that, according to the return data, resulted in a highest return of any action when performed by the agent in response to the first observation with probability 1-ε, and selects an action randomly from the predetermined set of actions with probability ε, where ε is a predetermined constant.

In response to determining that the current observation does not match any of the observations identified in the return data, i.e., the current observation is a new observation, the system selects an action to be performed by the agent using estimated returns (step 210). The process for selecting an action to be performed by the agent in response to a new observation is described in more detail below with reference to FIG. 3.

After the agent performs the selected action in response to the current observation, i.e., in response to being instructed or otherwise caused to perform the action by the system, the system receives a new return resulting from the agent performing the selected action.

The system then receives a next observation and continues determining whether the next observation matches any of the observations identified in the return data and selecting an action to be performed by the agent by following the above process.

In some implementations, the system can update the return data each time the system received a new return. In some other implementations, the system can update the return data only after receiving a predetermined number of new returns.

The system can update the return data using the new return resulting from the agent performing the selected action in response to the current observation as follows. When the current observation matches a first observation identified in the return data, the system determines whether the new return is larger than an existing return mapped to by the selected action-current observation pair, i.e., the return resulting from performing the selected action in response to the current observation according to the return data. When the new return is larger than the existing return, the system replaces the existing return with the new return in the return data. When the current observation does not match a first observation identified in the return data, the system updates the return data to map a current observation-selected action pair to the new return, i.e., by adding a new mapping to the return data.

In some implementations, after updating the return data, the system determines that a number of mappings in the return data has reached a maximum size and, in response, the system removes a least recently updated mapping from the return data.

FIG. 3 is a flow diagram of an example process 300 for selecting an action to be performed by an agent in response to a new observation. For convenience, the process 300 will be described as being performed by a system of one or more computers located in one or more locations. For example, a reinforcement learning system, e.g., the reinforcement learning system 100 of FIG. 1, appropriately programmed in accordance with this specification, can perform the process 300.

When the system receives a current observation and determines that the current observation does not match any of the observations identified in the return data, the system determines a feature representation of the current observation (step 302). For example, the feature representation of the current observation can be the current observation or, alternatively, a function of the current observation.

In some implementations, to reduce memory and computational requirements, the system determines a feature representation of the current observation by projecting the current observation into a smaller-dimensional space. For example, the system applies a random projection matrix to the current observation as follows:

$$ϕ : x \to Ax ,$$

where φ is the feature representation of the current observation χ, A∈ [symbol] is a random projection matrix, F is a projected dimension with F«D, where D is the dimensionality of the current observation.

In some other implementations, the system determines the feature representation of the current observation by processing the current observation using a variational auto-encoder (VAE) model to generate a latent representation of the current observation, and using the latent representation of the current observation as the feature representation of the current observation. Generally, a VAE model includes two neural networks: an encoder neural network that receives observations and maps them into corresponding representations of the observations, and a decoder neural network that receives representations and approximately recovers the observations corresponding to the representations. For example, an encoder neural network may include convolutional neural network layers followed by a fully connected neural network layer from which a linear neural network layer outputs representations of the received observations. A decoder neural network generally mirrors the structure of its corresponding encoder neural network. For example, the decoder neural network corresponding to the above-described encoder neural network includes a fully connected neural network layer followed by reverse convolutional neural network layers.

Next, the system determines the k observations identified in the return data that have feature representations that are closest to the feature representation of the current observation (step 304). For example, the system determines the k observations identified in the return data that have feature representations that have a smallest Euclidian distance to the feature representation of the current observation. Generally, k is a predetermined integer that is greater than one and is much smaller than the total number of observations identified in the return data. In some cases, k is an integer that is in the range of five to fifty, inclusive.

The system then determines a respective estimated return for each of multiple actions in the predetermined set of actions from returns mapped to by observation-action pairs in the return data that include the action and any one of the k observations (step 306). That is, for each action a in the multiple actions, the system determines a set of observation-action pairs that include one of the k observations and action a. The system then determines an average or other measure of central tendency of returns mapped to by the set of observation-action pairs in the return data. For example, the system can sum up the returns mapped to by the set of observation-action pairs in the return data and divide the sum by the number of pairs in the set of observation-action pairs.

After determining an estimated return for each of the multiple actions, the system selects an action to be performed by the agent in response to the current observation using the estimated returns (step 308). In some implementations, the system selects an action from the multiple actions that has the highest estimated return. In some other implementations, the system selects an action from the plurality of actions that has the highest estimated return with probability 1-ε and selects an action randomly from the predetermined set of actions with probability ε.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows can be performed by and apparatus can also be implemented as a graphics processing unit (GPU).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A computer-implemented method for robot control using return data, the computer-implemented method being performed by a model-free controller implemented by one or more computers and comprising:
maintaining return data that records outcomes of past robot actions, wherein the return data maps each of a plurality observation-action pairs to a respective return,
wherein the action in each observation-action pair is an action that was performed by the robot in response to the observation in the observation-action pair, and
wherein the respective return mapped to by each of the observation-action pairs is an actual return that resulted from the robot performing the action in the observation-action pair in response to the observation in the observation-action pair;
receiving a current observation characterizing a current state of the environment, wherein the current observation is generated from data captured by one or more sensors of the robot as the robot interacts with the environment;
determining whether the current observation matches any of the observations identified in the return data;
in response to determining that the current observation does not match any of the observations identified in the return data:
determining a feature representation of the current observation by projecting the current observation into a space having a projected dimension smaller than a dimensionality of the current observation;
selecting a plurality of observations identified in the return data that have feature representations closest to the determined feature representation of the current observation;
for each action of a plurality of actions in the predetermined set of actions,
determining observation-action pairs in the return data that include the action and any one of the plurality of selected observations, and
determining a respective estimated return for each action based on returns mapped to by the determined observation-action pairs in the return data, comprising:
combining the returns mapped to by observation-action pairs in the return data that include the action and any one of the plurality of selected observations,
wherein for at least one of the plurality of actions, combining the returns comprises: combining two or more returns mapped to by two or more different observation-action pairs that each include the action but include different observations in the selected plurality of observations that have the feature representations closest to the determined feature representation of the current observation; and
selecting the action to be performed by the robot in response to the current observation using the estimated returns; and
controlling the robot based on the selected action, comprising controlling the robot to interact with the environment to accomplish a specific task or to navigate through the environment.

2. The computer-implemented method of claim 1, wherein for each of the plurality of actions, combining the returns mapped to by observation-action pairs in the return data that include the action and any one of the plurality of selected observations comprises:
determining an average of the returns mapped to by observation-action pairs in the return data that include the action and any one of the plurality of selected observations.

3. The computer-implemented method of claim 1, wherein selecting the action to be performed by the robot comprises:
selecting an action from the plurality of actions that has the highest estimated return.

4. The computer-implemented method of claim 1, wherein selecting the action to be performed by the robot comprises:
selecting an action from the plurality of actions that has the highest estimated return with probability 1-ε; and
selecting an action randomly from the predetermined set of actions with probability ε.

5. The computer-implemented method of claim 1, wherein selecting the plurality of observations identified in the return data that have feature representations closest to the determined feature representation of the current observation comprises:
selecting the plurality of observations identified in the return data that have feature representations that have a smallest Euclidian distance to the feature representation of the current observation.

6. The computer-implemented method of claim 1, wherein the feature representation of the current observation is the current observation.

7. The computer-implemented method of claim 1, wherein projecting the current observation into the space comprises applying a random projection matrix to the current observation.

8. The computer-implemented method of claim 1, wherein determining the feature representation of the current observation comprises:
processing the current observation using a variational auto-encoder model to generate a latent representation of the current observation; and
using the latent representation of the current observation as the feature representation of the current observation.

9. The computer-implemented method of claim 1, further comprising:
receiving a new return resulting from the robot performing the selected action in response to the current observation; and
updating the return data using the new return.

10. The computer-implemented method of claim 9, wherein, when the current observation matches a first observation identified in the return data, updating the return data using the new return comprises:
determining whether the new return is larger than an existing return resulting from performing the selected action in response to the first observation according to the return data; and
when the new return is larger than the existing return, replacing the existing return with the new return in the return data.

11. The computer-implemented method of claim 9, wherein, when the current observation does not match any of the observations identified in the return data, updating the return data using the new return comprises:
updating the return data to map a current observation-selected action pair to the new return.

12. The computer-implemented method of claim 1, further comprising:
determining that a number of mappings in the return data has reached a maximum size and, in response, removing a least recently updated mapping from the return data.

13. The computer-implemented method of claim 1, further comprising:
initializing the return data with initial mappings by randomly selecting actions to be performed by the robot until each action in the predetermined set of actions has been performed more than a threshold number of times.

14. The computer-implemented method of claim 1, wherein the returns are discounted sums of rewards received by the robot in response to performing actions.

15. A system comprising one or more computers and one or more storage devices storing instructions that, when executed by the one or more computers, cause the one or more computers to implement a model-free controller for robot control using return data, the operations comprising:
maintaining return data that records outcomes of past robot actions, wherein the return data maps each of a plurality observation-action pairs to a respective return,
wherein the action in each observation-action pair is an action that was performed by the robot in response to the observation in the observation-action pair, and
wherein the respective return mapped to by each of the observation-action pairs is an actual return that resulted from the robot performing the action in the observation-action pair in response to the observation in the observation-action pair;
receiving a current observation characterizing a current state of the environment, wherein the current observation is generated from data captured by one or more sensors of the robot as the robot interacts with the environment;
determining whether the current observation matches any of the observations identified in the return data;
in response to determining that the current observation does not match any of the observations identified in the return data:
determining a feature representation of the current observation by projecting the current observation into a space having a projected dimension smaller than a dimensionality of the current observation;
selecting a plurality of observations identified in the return data that have feature representations closest to the determined feature representation of the current observation;
for each action of a plurality of actions in the predetermined set of actions,
determining observation-action pairs in the return data that include the action and any one of the plurality of selected observations, and
determining a respective estimated return for each action based on returns mapped to by the determined observation-action pairs in the return data, comprising:
combining the returns mapped to by observation-action pairs in the return data that include the action and any one of the plurality of selected observations,
wherein, for at least one of the plurality of actions, combining the returns comprises: combining two or more returns mapped to by two or more different observation-action pairs that each include the action but include different observations in the selected plurality of observations that have the feature representations closest to the determined feature representation of the current observation; and
selecting the action to be performed by the robot in response to the current observation using the estimated returns; and
controlling the robot based on the selected action, comprising controlling the robot to interact with the environment to accomplish a specific task or to navigate through the environment.

16. A non-transitory computer storage medium encoded with instructions that, when executed by one or more computers, cause the one or more computers to implement a model-free controller to perform operations for robot control using return data, the operations comprising:
maintaining return data that records outcomes of past robot actions, wherein the return data maps each of a plurality observation-action pairs to a respective return,
wherein the action in each observation-action pair is an action that was performed by the robot in response to the observation in the observation-action pair, and
wherein the respective return mapped to by each of the observation-action pairs is a return that resulted from the robot performing the action in the observation-action pair in response to the observation in the observation-action pair;
receiving a current observation characterizing a current state of the environment, wherein the current observation is generated from data captured by one or more sensors of the robot as the robot interacts with the environment;
determining whether the current observation matches any of the observations identified in the return data;
in response to determining that the current observation does not match any of the observations identified in the return data:
determining a feature representation of the current observation by projecting the current observation into a space having a projected dimension smaller than a dimensionality of the current observation;
selecting a plurality of observations identified in the return data that have feature representations closest to the determined feature representation of the current observation;
for each action of a plurality of actions in the predetermined set of actions,
determining observation-action pairs in the return data that include the action and any one of the plurality of selected observations, and
determining a respective estimated return for each action based on returns mapped to by the determined observation-action pairs in the return data, comprising:
combining the returns mapped to by observation-action pairs in the return data that include the action and any one of the plurality of selected observations,
wherein, for at least one of the plurality of actions, combining the returns comprises: combining two or more returns mapped to by two or more different observation-action pairs that each include the action but include different observations in the selected plurality of observations that have the feature representations closest to the determined feature representation of the current observation; and
selecting the action to be performed by the robot in response to the current observation using the estimated returns; and
controlling the robot based on the selected action, comprising controlling the robot to interact with the environment to accomplish a specific task or to navigate through the environment.

17. A computer-implemented method for robot control using return data, the computer-implemented method being performed by a model-free controller implemented by one or more computers, the computer-implemented method comprising:
maintaining return data that records outcomes of past robot actions, wherein the return data maps each of a plurality observation-action pairs to a respective return,
wherein the action in each observation-action pair is an action that was performed by the robot in response to the observation in the observation-action pair, and
wherein the respective return mapped to by each of the observation-action pairs is a return that resulted from the robot performing the action in the observation-action pair in response to the observation in the observation-action pair;
receiving a current observation characterizing a current state of the environment, wherein the current observation is generated from data captured by one or more sensors of the robot as the robot interacts with the environment;
determining whether the current observation matches any of the observations identified in the return data; and
in response to determining that the current observation does not match any of the observations identified in the return data:
determining a feature representation of the current observation by projecting the current observation into a space having a projected dimension smaller than a dimensionality of the current observation;
determining k observations identified in the return data that have feature representations that are closest to the feature representation of the current observation, wherein k is an integer greater than one;
determining a respective estimated return for each of a plurality of actions in the predetermined set of actions from returns mapped to by observation-action pairs in the return data that include the action and any one of the k observations, comprising:
combining the returns mapped to by observation-action pairs in the return data that include the action and any one of the k observations,
wherein, for at least one of the plurality of actions, combining the returns comprises: combining two or more returns mapped to by two or more different observation-action pairs that each include the action but include different observations in the k observations that have the feature representations closest to the feature representation of the current observation; and
selecting the action to be performed by the robot in response to the current observation using the estimated returns; and
controlling the robot based on the selected action, comprising controlling the robot to interact with the environment to accomplish a specific task or to navigate through the environment.
